(19) United States
(12) Patent Application Publication
(10) Pub. No.: US 2026/0030303 A1
(43) Pub. Date: Jan. 29, 2026

(54) PERSONALIZED CONTENT DELIVERY BASED ON SCREENSHOT ANALYSIS

(71) Applicant: MOTOROLA MOBILITY LLC, WILMINGTON, DE (US)

(72) Inventors: AMIT KUMAR AGRAWAL, BANGALORE (IN); KRISHNAN RAGHAVAN, BANGALORE (IN)

(21) Appl. No.: 18/784,609

(22) Filed: Jul. 25, 2024

(51) Int. Cl. G06F 16/9535; G06Q 30/0251; G06V 30/10; H04L 67/55

(52) U.S. Cl. CPC G06F 16/9535; G06Q 30/0251; G06V 30/10; H04L 67/55

(57) ABSTRACT

A method provides techniques for personalized content delivery based on screenshot analysis. Image data of a screenshot is obtained by a processor of a communication device that comprises a display. A screenshot analysis record (SAR) is created by performing an analysis of the screenshot. The SAR is transmitted to a remote computing device that supports a personalization engine and a recommendation engine. At least one personalized content asset is received, based at least in part, on the SAR. The display is modified by rendering the at least one personalized content asset on the display.

### BACKGROUND

### 1. Technical Field

The present disclosure generally relates to electronic devices, and more specifically to electronic devices that enable rendering of media on an electronic display.

### 2. Description of the Related Art

Targeted advertisements and other personalized content presented on electronic devices such as smartphones, provide numerous benefits for consumers, enhancing their overall experience and satisfaction. Personalized content provides increased relevance, as the content is tailored to the consumer's interests and preferences, making the content more relevant and engaging, and leading to longer interaction times and higher satisfaction. Targeted advertisements (ads) can be interactive and immersive, providing a richer experience for the consumer. Furthermore, consumers feel understood and valued when the content they receive matches their interests and needs. Moreover, personalized content can provide consumers with valuable information and insights related to their interests or recent activities.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example component makeup of an electronic device with specific components that enable the device to implement personalized content delivery based on screenshot analysis, according to one or more embodiments;

FIG. 2 is an example illustration of an electronic device transmitting a request for personalized content delivery based on screenshot analysis, according to one or more embodiments;

FIG. 3 depicts an exemplary screenshot on an electronic device that is used for personalized content delivery based on screenshot analysis, according to one or more embodiments;

FIG. 4 depicts a user interface including personalized content delivery based on screenshot analysis, according to one or more embodiments;

FIG. 5 depicts an exemplary data structure used for implementing personalized content delivery based on screenshot analysis, according to one or more embodiments;

FIG. 6 depicts a flowchart of a computer-implemented method for personalized content delivery based on screenshot analysis, according to one or more embodiments; and

FIG. 7 depicts a flowchart of a computer-implemented method for using an interest score to perform personalized content delivery based on screenshot analysis, according to one or more embodiments.

### DETAILED DESCRIPTION

According to aspects of the present disclosure, an electronic device, a method, and a computer program product provide techniques for personalized content delivery based on screenshot analysis. A screenshot is a saved image capture of content that is currently being rendered on an electronic display of a device. In one or more embodiments, when a screenshot is obtained, one or more elements within the screenshot are analyzed. The elements can include text, images, a uniform resource locater (URL) associated with the content in the screenshot, and/or other metadata. Based on the analyzed elements, personalized content is delivered to the electronic device. The personalized content can include advertisements, video recommendations, audio recommendations, and/or other types of personalized content. Accordingly, disclosed embodiments can provide significant benefits to users by making their online experiences more relevant, efficient, and enjoyable.

When a user shares content, such as text and/or images, via an online platform such as a social media platform, what the user has shared can be readily ascertained. The sharing habits of a user can help infer interests of the user, which can in turn drive decisions on what personalized content the user may appreciate. However, there are various ways to share content with an electronic device. One common way is to take a screenshot of the displayed content that is currently rendered on a display of an electronic device, and share that content via text messaging, email, application messaging, and/or posting on an online platform. There are various reasons and motivations for sharing content via sending of screenshots. Some users who engage with content on social media platforms have various reasons for using the platform's sharing options, such as “Like” and “Retweet.” However, other users may prefer to acquire and send screenshots to share content privately with friends. Some users may prefer to maintain a degree of anonymity on a social media platform. They may appreciate or find content interesting but might not want others to know about their engagement. Sharing a screenshot offers a discreet alternative. Additionally, screenshot sharing can be a form of cross-platform sharing. Social media users often have diverse online networks. They might use one platform primarily for consumption, such as X (formerly Twitter) for reading news, while their friends are active on other platforms like Messenger or WhatsApp. Screenshots allow them to share content seamlessly across platforms, ensuring it reaches the right audience without breaking the user experience. Other reasons for screenshot-sharing might include wanting to curate content for personal collections, saving it for later reference, or simply enjoying the act of sharing something tangible with friends outside the platform's constraints. While screenshot sharing offers users' privacy and versatility, it can limit platforms' access to valuable data about user interests. In these instances of screenshot sharing, the information about what is being shared can go undetected by traditional methods, thereby missing opportunities to personalize content based on the sharing of the information.

The disclosed embodiments alleviate the aforementioned issues that can occur when sharing content via screenshots. By analyzing the content (text and/or images) within the screenshots, and determining the sharing patterns of those screenshots, personalized content delivery based on screenshot analysis can be implemented.

According to one or more embodiments, a screenshot is analyzed. Lists of text and/or objects identified in the screenshot are recorded. Moreover, sharing information is recorded, such as a count of how many times a screenshot has been shared, and/or to how many distinct destinations a screen shot has been shared. Additionally, an interest score can be computed based on the sharing information and/or the content within the screenshot, thereby providing opportunities for delivering personalized content based on screenshots that are being shared.

One or more embodiments can include an electronic (communication) device including: at least one output device, including a display; a communications subsystem; a memory having stored thereon a screenshot analysis (SA) module; and at least one processor communicatively coupled to the display, the communication system, and the memory. The at least one processor executes program code of the SA module and is configured to cause the communication device to: obtain image data for a screenshot of an image that is rendered on the display; create a screenshot analysis record (SAR) by performing an analysis of the screenshot; transmit the SAR to a remote computing device that supports a personalization engine and a recommendation engine; receive, in part based on the SAR, at least one personalized content asset; and modify the display by rendering the at least one personalized content asset on the display.

The above descriptions contain simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, and configuring the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one implementation (embodiment) of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

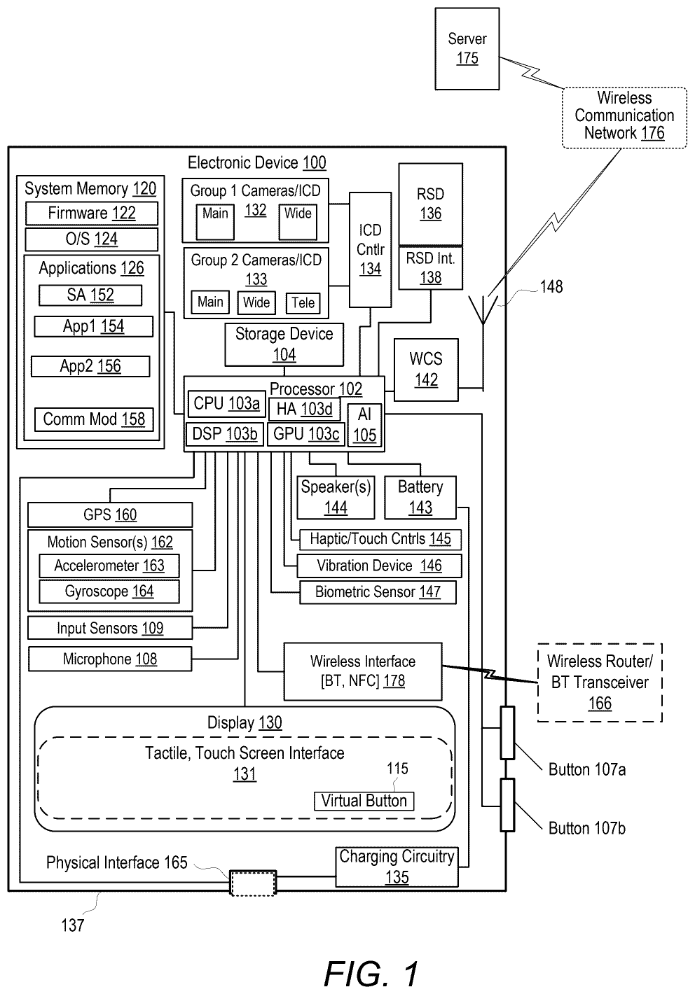

Those of ordinary skill in the art will appreciate that the hardware components and basic configuration depicted in the following figures may vary. For example, the illustrative components within electronic device 100 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

Referring now to the figures and beginning with FIG. 1, there is illustrated an example component makeup of electronic device 100, within which various aspects of the disclosure can be implemented, according to one or more embodiments. Electronic device 100 includes specific components that enable the device to provide personalized content delivery based on screenshot analysis, according to one or more embodiments. Examples of electronic device 100 include, but are not limited to, mobile devices, a notebook computer, a mobile phone, a smart phone, a digital camera with enhanced processing capabilities, a smart watch, a tablet computer, and other types of electronic device.

Electronic device 100 includes processor 102 (typically as a part of a processor integrated circuit (IC) chip), which includes processor resources such as central processing unit (CPU) 103a, communication signal processing resources such as digital signal processor (DSP) 103b, graphics processing unit (GPU) 103c, and hardware acceleration (HA) unit 103d. In some embodiments, the hardware acceleration (HA) unit 103d may establish direct memory access (DMA) sessions to route network traffic to various elements within electronic device 100 without direct involvement from processor 102 and/or operating system 124. Processor 102 can interchangeably be referred to as controller 102.

Processor 102 can, in some embodiments, include image signal processors (ISPs) (not shown) and dedicated artificial intelligence (AI) engines 105. In one or more embodiments, processor 102 can execute AI modules to provide AI functionality of AI engines 105. AI modules may include an artificial neural network, a decision tree, a support vector machine, Hidden Markov model, linear regression, logistic regression, Bayesian networks, and so forth. The AI modules can be individually trained to perform specific tasks and can be arranged in different sets of AI modules to generate different types of output. Processor 102 is communicatively coupled to storage device 104, system memory 120, input devices (introduced below), output devices, including integrated display 130, and image capture device (ICD) controller 134.

ICD controller 134 can perform image acquisition functions in response to commands received from processor 102 in order to control group 1 ICDs 132 and group 2 ICDs 133 to capture video or still images of a local scene within a FOV of the operating/active ICD. In one or more embodiments, group 1 ICDs can be front-facing, and group 2 ICDs can be rear-facing, or vice versa. Throughout the disclosure, the term image capturing device (ICD) is utilized interchangeably to be synonymous with and/or refer to any one of the cameras 132, 133. Both sets of cameras 132, 133 include image sensors that can capture images that are within the field of view (FOV) of the respective camera 132, 133.

In one or more embodiments, the functionality of ICD controller 134 is incorporated within processor 102, eliminating the need for a separate ICD controller. Thus, for simplicity in describing the features presented herein, the various camera selection, activation, and configuration functions performed by the ICD controller 134 are described as being provided generally by processor 102. Similarly, manipulation of captured images and videos are typically performed by GPU 103c and certain aspects of device communication via wireless networks are performed by DSP 103b, with support from CPU 103a. However, for simplicity in describing the features of the electronic device 100, the functionality provided by one or more of CPU 103a, DSP 103b, GPU 103c, and ICD controller 134 are collectively described as being performed by processor 102 (or controller 102). Collectively, components integrated within processor 102 support computing, classifying, processing, transmitting and receiving of data and information, and presenting of graphical images within a display.

System memory 120 may be a combination of volatile and non-volatile memory, such as random-access memory (RAM) and read-only memory (ROM). System memory 120 can store program code or similar data associated with firmware 122, an operating system 124, and/or applications 126. During device operation, processor 102 processes program code of the various applications, modules, OS, and firmware, that are stored in system memory 120.

In accordance with one or more embodiments, applications 126 include, without limitation, SA module 152, other applications, indicated as App1 154 and App2 156, and communication module 158. Other applications may also be present. Each module and/or application provides program instructions/code that are processed by processor 102 to cause/configure processor 102 and/or other components of electronic device 100 to perform specific operations, as described herein. Descriptive names assigned to these modules add no functionality and are provided solely to identify the underlying features performed by processing the different modules. For example, SA module 152 can include program instructions for implementing features of disclosed embodiments. In one or more embodiments, the SA module 152 includes program instructions that cause the electronic device to analyze content within a screenshot, including text and/or object identification. Additionally, the SA module 152 may include program instructions that cause the electronic device to perform natural language processing (NLP) on text recognized via optical character recognition (OCR) techniques. The NLP can determine a subject and/or sentiment based on the text within the screenshot. In one or more embodiments, the subject and/or sentiment can be used as criteria in determining personalized content for delivery to the electronic device 100.

In one or more embodiments, electronic device 100 includes removable storage device (RSD) 136, which is inserted into RSD interface 138 that is communicatively coupled via system interlink to processor 102. In one or more embodiments, RSD 136 is a non-transitory computer program product or computer readable storage device encoded with program code and corresponding data, and RSD 136 can be interchangeably referred to as a non-transitory computer program product. RSD 136 may have a version of one or more applications stored thereon. Processor 102 can access RSD 136 to provision electronic device 100 with program code that, when executed/processed by processor 102, the program code causes or configures processor 102 and/or generally electronic device 100, to provide the various functions described herein.

Electronic device 100 includes an integrated display 130 which incorporates a tactile, touch screen interface 131 that can receive user tactile/touch input. As a touch screen device, integrated display 130 with tactile, touch screen interface 131 can be utilized as an input device that allows a user to provide input to or to control electronic device 100 by touching features within the user interface presented on display 130. The touch screen interface 131 can include one or more virtual buttons or other selectable items, indicated generally as 115. In one or more embodiments, when a user applies a finger on the touch screen interface 131 in the region demarked by the virtual button 115, the touch of the region causes the processor 102 to execute code to implement a function associated with the virtual button. In some implementations, integrated display 130 is integrated into a front surface of electronic device 100 along with front ICDs, while the higher quality ICDs are located on a rear surface.

Electronic device 100 can further include microphone 108, one or more output devices such as speakers 144, and one or more input buttons, indicated as 107a and 107b. While two buttons are shown in FIG. 1, other embodiments may have more or fewer input buttons. Microphone 108 can also be referred to as an audio input device. In some embodiments, microphone 108 may be used for identifying a user via voiceprint, voice recognition, and/or other suitable techniques. Input buttons 107a and 107b may provide controls for volume, power, and ICDs 132, 133. Additionally, electronic device 100 can include input sensors 109 (e.g., sensors enabling gesture detection by a user).

Electronic device 100 further includes haptic touch controls 145, vibration device 146, fingerprint/biometric sensor 147, global positioning system (GPS) module 160, and motion sensor(s) 162. Vibration device 146 can cause electronic device 100 to vibrate or shake when activated. Vibration device 146 can be activated during an incoming call or message in order to provide an alert or notification to a user of electronic device 100. According to one aspect of the disclosure, integrated display 130, speakers 144, and vibration device 146 can generally and collectively be referred to as output devices.

Biometric sensor 147 can be used to read/receive biometric data, such as fingerprints, to identify or authenticate a user. In some embodiments, an ICD can be utilized as a biometric sensor for facial recognition and biometric sensor 147 can be in addition to and supplement an ICD (camera) for user detection/identification.

GPS module 160 can provide time data and location data about the physical location of electronic device 100 using geospatial input received from GPS satellites. Motion sensor(s) 162 can include one or more accelerometers 163 and gyroscope 164. Motion sensor(s) 162 can detect movement of electronic device 100 and provide motion data to processor 102 indicating the spatial orientation and movement of electronic device 100. Accelerometers 163 measure linear acceleration of movement of electronic device 100 in multiple axes (X, Y, and Z). Gyroscope 164 measures rotation or angular rotational velocity of electronic device 100. Electronic device 100 further includes a housing 137 (generally represented by the thick exterior rectangle) that contains/protects the components internal to electronic device 100.

Electronic device 100 also includes a physical interface 165. Physical interface 165 of electronic device 100 can serve as a data port and can also be used as a power supply port that is coupled to charging circuitry 135 and device battery 143 to enable recharging of device battery 143 and/or powering of device.

Electronic device 100 further includes wireless communication subsystem (WCS) 142, which can represent one or more front end devices (not shown) that are each coupled to one or more antennas 148. In one or more embodiments, WCS 142 can include one or more baseband processors or digital signal processors, one or more modems, and a radio frequency (RF) front end having one or more transmitters and one or more receivers. Example communication module 158 within system memory 120 enables electronic device 100 to communicate with wireless communication network 176 and with other devices, such as server 175 and other connected devices, via one or more of data, audio, text, and video communications. Communication module 158 can support various communication sessions by electronic device 100, such as audio communication sessions, video communication sessions, text communication sessions, exchange of data, and/or a combined audio/text/video/data communication session.

WCS 142 and antennas 148 allow electronic device 100 to communicate wirelessly with wireless communication network 176 via transmissions of communication signals to and from network communication devices, such as base stations or cellular nodes, of wireless communication network 176. Wireless communication network 176 further allows electronic device 100 to wirelessly communicate with server 175, and other communication devices, which can be similarly connected to wireless communication network 176 or connected via a wide area network (WAN), such as the Internet. In one or more embodiments, various functions that are being performed on communications device 100 can be supported using or completed via/on server 175. In one or more embodiments, server 175 can store images, such as captured screenshots, and/or metadata pertaining to captured screenshots. Moreover, in one or more embodiments, based on the captured screenshots, and/or metadata pertaining to captured screenshots, server 175 can perform screenshot analysis and recommend and/or enable personalized content delivery based on screenshot analysis.

Electronic device 100 can also wirelessly communicate, via wireless interface(s) 178, with wireless communication network 176 via communication signals transmitted by short range communication device(s). Wireless interface(s) 178 can include transceivers, and/or a short-range wireless communication component providing Bluetooth, near field communication (NFC), and/or wireless fidelity (Wi-Fi) connections. In one or more embodiments, electronic device 100 can receive Internet or Wi-Fi based calls, text messages, multimedia messages, and other notifications via wireless interface(s) 178. In one or more embodiments, electronic device 100 can communicate wirelessly with external wireless device 166, such as a WiFi router or BT transceiver, via wireless interface(s) 178. In one or more embodiments, WCS 142 with antenna(s) 148 and wireless interface(s) 178 collectively provide wireless communications subsystem of electronic device 100.

Electronic device 100 of FIG. 1 is only a specific example of a device that can be used to implement the embodiments of the present disclosure. Devices that utilize aspects of the disclosed embodiments can include, but are not limited to, a smartphone, a tablet computer, a laptop computer, a desktop computer, a wearable computer, and/or other suitable electronic device.

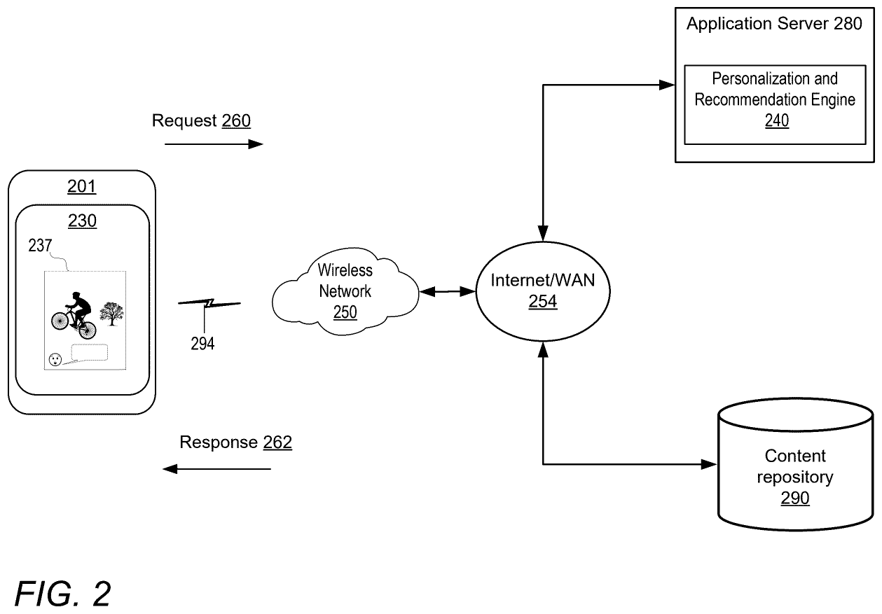

FIG. 2 is an example illustration of an electronic device transmitting a request for personalized content delivery based on screenshot analysis, to an application computer system, such as application server 280, and receiving a response from the application computer system indicating personalized content based on screenshot analysis, according to one or more embodiments. Device 201 includes a display 230 on which an acquired screenshot 237 is displayed. Device 201 can be an implementation of electronic device 100, having similar components and/or functionality. The screenshot 237 is acquired (captured) by device 201 using available screen capture functionality of device 201. In one or more embodiments, at least some of the personalized content selection, delivery, and/or screenshot analysis functions may be implemented on a network-accessible application server, such as indicated by application server 280. In one or more embodiments, the screenshot 237 can be sent to the application server 280 for analysis by personalization and recommendation engine 240. Application server 280 is communicatively coupled to Internet/WAN 254, which can include one or more wide area networks (WANs), such as the Internet. In one or more embodiments, electronic device 201 can communicate wirelessly with wireless network 250 via transmissions of communication signals 294 to and from network communication devices, such as base stations or cellular nodes, that are components of network 250. The application server 280 and electronic device 201 may communicate with each other via Internet/WAN 254. Network 250 enables exchange of data between electronic device 201 and application server 280, via Internet/WAN 254.

Application server 280 can host personalization and recommendation engine 240. The personalization and recommendation engine 240 can utilize screenshot data obtained from device 201. In one or more embodiments, the personalization and recommendation engine 240 can send content and or links to content stored in content repository 290 to the device 201. The content repository 290 can include one or more video assets, image assets, and/or other media types that can be used as personalized content that can be delivered to device 201 based on screenshot analysis. In one or more embodiments, an artificial intelligence (AI) enabled filtering process selects one or more assets from the content repository 290 for serving to a particular electronic device.

In one or more embodiments, request 260 and response 262 may utilize Hypertext Transfer Protocol (HTTP) and/or its secure counterpart HTTPS. Embodiments may use RESTful APIs, JavaScript Object Notation (JSON), Simple Object Access Protocol (SOAP), and/or other communication techniques for exchanging information. In one or more embodiments, in order to support scalability and/or case of maintenance, application server 280 may be implemented via virtualization, such as utilizing hypervisors like VMware, Hyper-V, or KVM. One or more embodiments may include containerization services such as docker, LXC, or other suitable container framework to enable multiple isolated user-space instances. Additionally, one or more embodiments may include load balancing and/or orchestration, such as utilizing Kubernetes, or other suitable orchestration framework.

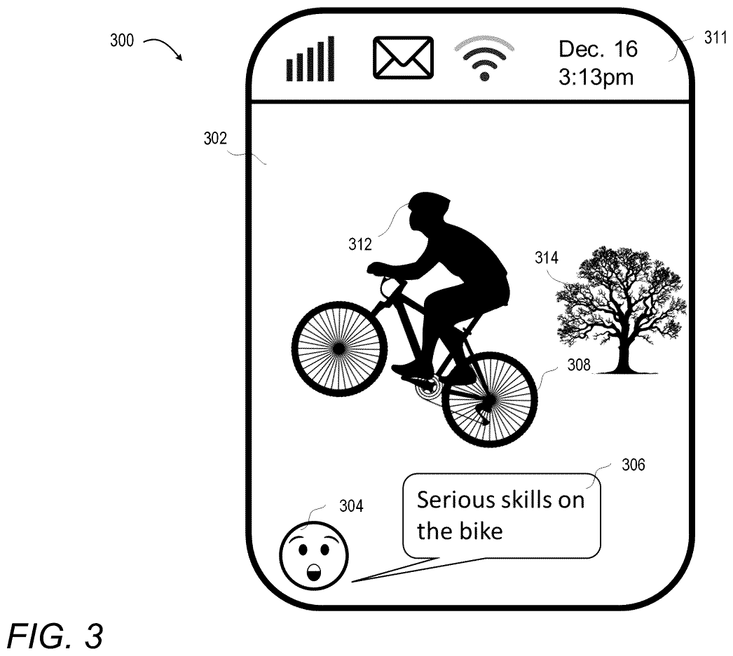

FIG. 3 depicts an exemplary screenshot on an electronic device 300 that is used for personalized content delivery based on screenshot analysis, according to one or more embodiments. In one or more embodiments, the user interface shown in FIG. 3 may be rendered on a display 302 of a device, such as device 100 of FIG. 1 and device 201 of FIG. 2. The rendered content on display 302 shown in FIG. 3 includes numerous elements. The elements include an image of a bicycle 308 with a rider 312 thereon. Additionally, the rendered content includes an image of a tree 314, a face 304, and text 306. A status area 311 shows various pieces of information, such as signal strength, an indication of new messages available, and a date and time, indicated as December 16, 3:13 pm in this example. A user may acquire a screenshot by executing a predetermined command sequence. As an example, the predetermined command sequence can include pressing and holding a power button and a volume-down button, simultaneously pressing and releasing a side button and a volume-up button, or other suitable button-pressing sequence (e.g., via buttons 107a and/or 107b of FIG. 1). Additionally, one or more embodiments may support gesture-based and/or voice-activated screenshot acquisition. For example, for a voice-activated screenshot acquisition, a user may utter ‘Hey Google’ and then shortly thereafter, utter ‘take a screenshot’ to cause the electronic device to capture a screenshot image file and save the screenshot image file in memory on the electronic device, such as in a screenshots folder. In one or more embodiments, in response to a screenshot image file being saved, program instructions within the SA module 152 (FIG. 1) cause the electronic device 300 to perform an analysis of the screenshot. The analysis can include machine-learning based analysis utilizing dedicated artificial intelligence (AI) engines 105 of FIG. 1. The analysis can include recognizing objects using object classification techniques. In one or more embodiments, the object classification techniques can include convolutional neural networks, transfer learning, region-based convolutional neural networks, semantic segmentation, and/or other suitable object classification techniques. The results of the analysis can be stored in a database on the electronic device as a metadata record. In embodiments, the metadata record can be sent to a remote computing device such as application server 280 (FIG. 2), and personalization and recommendation engine 240 (FIG. 2) can use the metadata to determine personalized content to provide to the electronic device.

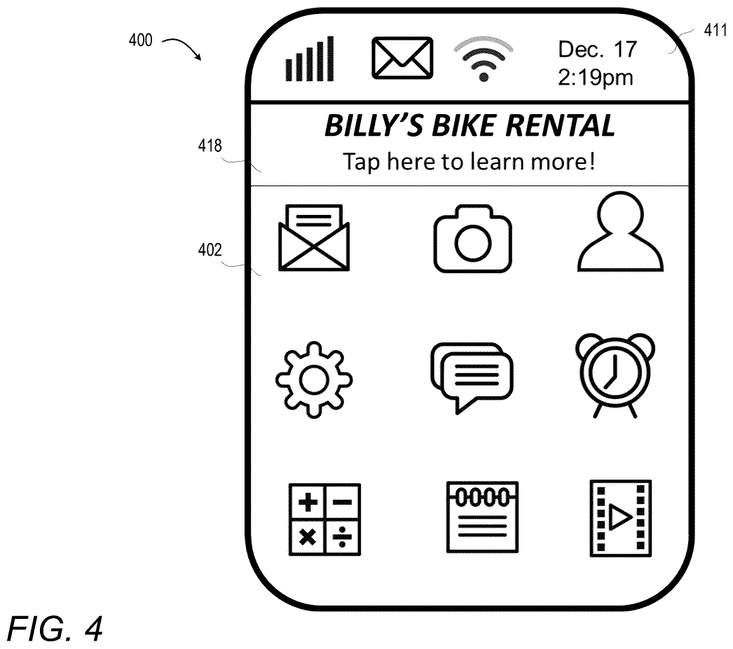

FIG. 4 depicts a user interface on an electronic device 400 including personalized content delivery based on screenshot analysis, according to one or more embodiments. In one or more embodiments, the user interface shown in FIG. 4 may be rendered on a display 402 of a device such as device 100 of FIG. 1 and device 201 of FIG. 2. The rendered content on display 402 shown in FIG. 4 includes the elements previously shown in FIG. 3 and described accordingly. FIG. 4 continues with the example from FIG. 3, where the user captures a screenshot of what is shown on electronic device 300 and the screenshot is transmitted to server 280 for analysis. Based on the analysis, personalized content 418 is sent from application server 280 (FIG. 2) to electronic device 400. The personalized content 418 can be an advertisement. The advertisement can include a hyperlink to obtain additional information. The personalized content 418 can include a link to a video asset, an audio asset, a product recommendation, a recommendation for a video to watch, and so on. In one or more embodiments, the personalized asset is transmitted via a push notification, and rendering the at least one personalized content asset on the display comprises rendering the push notification.

As can be seen in FIG. 4, the personalized content 418 is an advertisement for a bicycle (bike) rental business, based on the screenshot contents of FIG. 3 including a bicycle 308, along with rider 312, face 304, text 306, and tree 314. One or more embodiments may utilize techniques including a relative size and/or position of an object within a screenshot to determine relevance of the object. For example, the tree 314, located in the background of the image, and off to one side of the screenshot center, may be deemed irrelevant for the purposes of determining interest. However, the bike being at the fore-front of the image is deemed most relevant to the user's interest. Accordingly, the screenshot shown in FIG. 3 is deemed to be related to bicycles, and not to trees. In one or more embodiments, the personalized content may be pushed to the electronic device 400 shortly after the screenshot image is acquired. In one or more embodiments, the personalized content may be pushed to the electronic device 400 in a deferred manner. As can be seen in in FIG. 4, status bar 411 indicates a date and time of December 17, at 2:19 pm. Hence, the personalized content can be delivered hours, days, or weeks after a screenshot was acquired and/or shared.

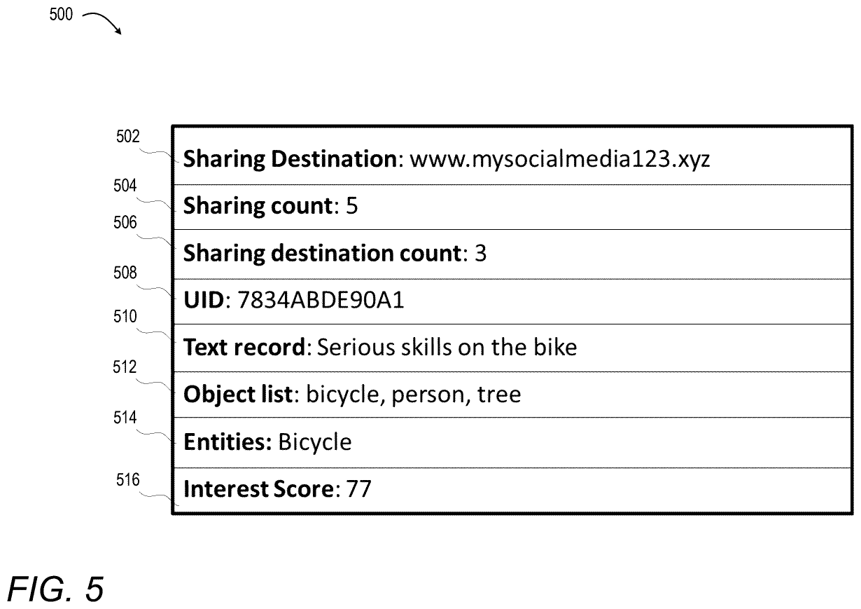

FIG. 5 depicts an exemplary data structure 500 used for implementing personalized content delivery based on screenshot analysis, according to one or more embodiments. Data structure 500 contains a screenshot analysis record that includes metadata about a screenshot. The metadata can include a sharing destination 502. The sharing destination can include a URL (uniform resource locator) of an online sharing platform, such as Instagram, Facebook, or the like. The sharing destination 502 may be implemented as a list to store multiple sharing destinations, including multiple URLs, email addresses, phone numbers, and the like. In one or more embodiments, the sharing destination may be anonymized when it refers to a specific person. In one or more embodiments, the sharing destination includes one of a URL, email address, and telephone number. Data structure 500 can further include a sharing count 504. The sharing count 504 can include a number of times a particular screenshot was shared. The sharing count 504 can include a count of how many times a screenshot was posted to an online platform specified in the sharing destination 502, and/or how many times a screenshot was sent via email, text message, and/or application message. Data structure 500 can further include a sharing destination count 506. The sharing destination count 506 can include a tally of unique destinations that a screenshot has been shared to. For example, if a screenshot was shared two times to the URL specified at 502, and sent to two recipients via email, then the sharing destination count is set to a value of 3, since there are three distinct destinations for the screenshot. Data structure 500 can further include a UID (unique identifier) 508. The UID 508 can include a value associated with a particular screenshot. In one or more embodiments, the UID is obtained by computing a hash of a screenshot image file. In one or more embodiments, an MD5 hash, SHA-1 hash, or other suitable hash is used as the UID. In one or more embodiments, a timestamp associated with a time of creation of the screenshot image file is used as the UID. In one or more embodiments, a combination of screenshot image file contents and a timestamp is hashed to create the UID. Other UID generation techniques are possible in one or more embodiments.

Data structure 500 can further include a text record 510. The text record 510 can include a list of words, phrases, and/or sentences detected in the screenshot via an optical character recognition process. In the example shown in FIG. 5, the text record 510 includes the phrase “Serious skills on the bike” which appears in the screenshot image, indicated as 406 in FIG. 4. One or more embodiments can include creating a text record as part of the SAR, wherein the text record includes text recognized by the OCR process. Data structure 500 can further include an object list 512. The object list 512 can include a list of objects recognized in the screenshot via object classification techniques. In the example shown in FIG. 5, the object list includes the objects of bicycle, person, and tree, which appear in the screenshot image, indicated as bicycle 308, rider 312, and tree 314 of FIG. 3. Thus, embodiments can include performing at least one of an optical character recognition (OCR) process on the screenshot and a machine-learning based object identification process on the screenshot. One or more embodiments can include creating an object list as part of the SAR, wherein the object list includes objects recognized by the machine-learning based object identification process. Data structure 500 can further include an entities field 514. The entities field 514 can include a list of one or more entities that indicate subject matter of the screenshot image. The determination of one or more entities can utilize natural language processing (NLP) techniques, including, but not limited to, named entity recognition (NER), sentiment analysis, text summarization, and topic modeling. The determination of one or more entities can include object detection. The object detection can utilize convolutional neural networks, attention networks, scene recognition, and/or other suitable object detection techniques.

Data structure 500 can further include an interest score 516. The interest score 516 can be indicative of a level of interest for the screenshot by the user. The interest score 516 can be based on the screenshot analysis. In particular, the interest score 516 can be computed as a function of the number of objects in the object list 512, the text indicated in the text record 510, one or more entities listed in entities field 514, number of times the screenshot image has been accessed and/or shared, and/or other associated data. In one or more embodiments, information in entities field 514 can be compared with a user profile that indicates interests. In one or more embodiments, the interest score can be a function of the number of entities that are also indicated as interests in a user profile. In embodiments, the interest score can be a number ranging from 0 (disinterested) to 100 (completely interested). Other scales for the interest score are possible in one or more embodiments. In one or more embodiments, data structure 500 is sent to a remote computing device, such as application server 280 (FIG. 2) when the screenshot is acquired. In one or more embodiments, data structure 500 is sent to a remote computing device, such as application server 280 (FIG. 2) only when the screenshot is shared. In one or more embodiments, data structure 500 is generated and updated at application server 280 based on receipt of the screenshot image for analysis. The updated data structure may then be shared with device, which can update values of the various entries in the data structure as the screen image is subsequently accessed and shared. In one or more embodiments, a user may opt in to use the feature of screenshot analysis to enable personalized content delivery based on screenshot analysis. Embodiments can include creating a unique identifier for the screenshot; recording a sharing count that represents a number of times the screenshot has been shared, and a sharing destination count of the screenshot that represents a number of distinct sharing destinations for the screenshot; and creating a sharing information record as part of the SAR, wherein the SAR includes the unique identifier, sharing count, and sharing destination count. In one or more embodiments, creating a unique identifier comprises computing a hash of the image data that comprises the screenshot.

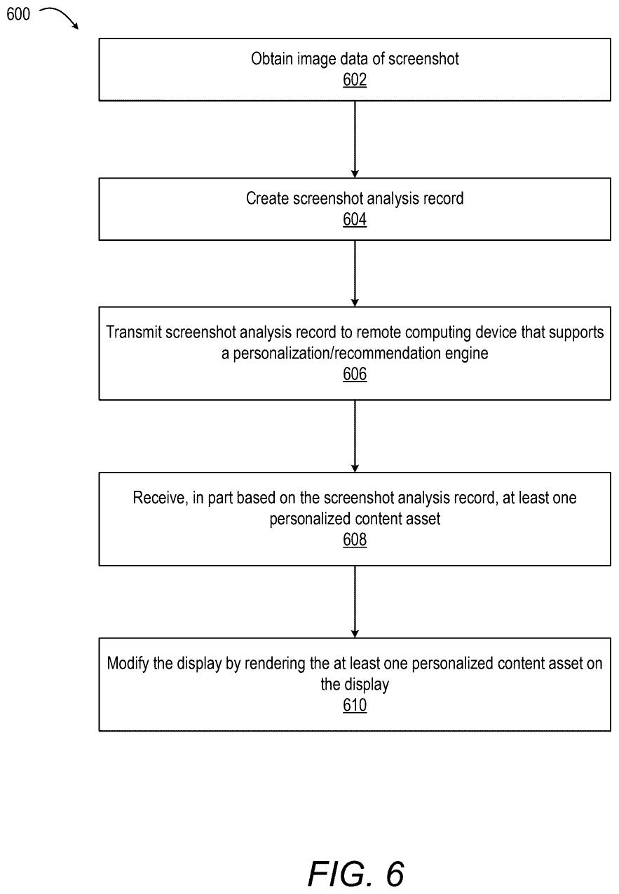

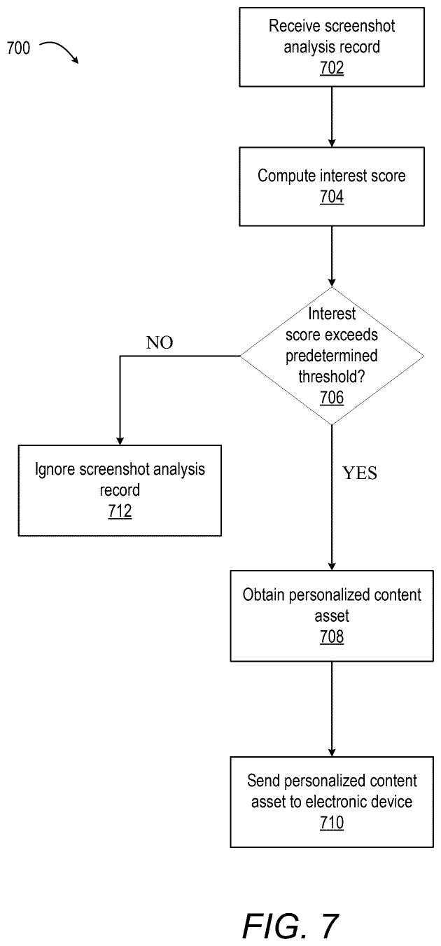

Referring now to the flowcharts presented by FIG. 6 and FIG. 7, the descriptions of the methods in by FIG. 6 and FIG. 7 are provided with general reference to the specific components and features illustrated within the preceding FIGS. 1-5. Specific components referenced in the methods of by FIG. 6 and FIG. 7 may be identical or similar to components of the same name used in describing preceding FIGS. 1-5. In one or more embodiments, processor 102 (FIG. 1) configures electronic device 100 (FIG. 1) to provide the described functionality of the methods of FIG. 6 and FIG. 7 by executing program code for one or more modules or applications provided within system memory 120 of electronic device 100, including SA module 152 (FIG. 1).

FIG. 6 depicts a flowchart of a computer-implemented method 600 for personalized content delivery based on screenshot analysis, according to one or more embodiments. The method 600 starts at block 602, where image data of a screenshot is obtained. The screenshot can be stored as an image file on an electronic device. In one or more embodiments, the image file can include a JPEG (Joint Photographic Experts Group) format, PNG (Portable Network Graphics) format, BMP (Bitmap) format, TIFF (Tagged Image File Format), HEIF (High Efficiency Image Format), and/or other suitable image file format. The screenshot can be acquired by a button press sequence, gesture, voice command, and/or other suitable technique. The method 600 continues to block 604 at which the processor creates a screenshot analysis record. An example of a screenshot analysis record is shown in FIG. 5. In one or more embodiments, the screenshot analysis record is created when the screenshot is acquired. In one or more embodiments, the screenshot analysis record is created when the screenshot is shared. The method 600 continues with transmitting the screenshot analysis record to a remote computing device that supports a personalization/recommendation engine (block 606). The remote computing device can be configured to serve personalized content to the electronic device that is the source of the screenshot. The personalized content can be based on one or more pieces of information contained within the screenshot analysis record. In one alternate embodiment, the screenshot image is shared with the remote computing device, which analyses the screenshot to generate the screenshot analysis record.

The method 600 includes receiving, in part based on the screenshot analysis record, at least one personalized content asset, at block 608. The personalized content asset can include a targeted advertisement. The targeted advertisement can include a banner advertisement, which can include rectangular advertisements that appear at the top or bottom of the device screen. The targeted advertisement can include an interstitial advertisement, which can include a full-screen advertisement that appears at natural transition points, such as at certain points during viewing of a video or audio clip, or between levels in a video game. The targeted advertisement can include a pre-roll advertisement that plays before video content, and/or a post-roll advertisement that plays after video content has ended. Other types of targeted advertisements are possible in disclosed embodiments. The personalized content asset can include an image file, a video file, and/or other types of multimedia files. The personalized content asset can include a push notification. The push notification can convey personalized offers, event reminders, and/or other associated information, based on the screenshot analysis record. The method 600 continues to block 610, where the display is modified by rendering the at least one personalized content asset on the display. In one or more embodiments, the personalized content asset may take up the full screen. In one or more embodiments, the personalized content asset may utilize a portion of the full screen, such as shown at 418 in FIG. 4. In one or more embodiments, the personalized content asset may be rendered opaque, such that the personalized content completely obscures its portion of the screen. In one or more embodiments, the personalized content asset may be rendered translucent, utilizing alpha-blending, such that previously rendered content is at least partially visible within the personalized content asset. Other personalized content presentation techniques are possible in disclosed embodiments.

FIG. 7 depicts a flowchart of a computer-implemented method 700 for using an interest score to perform personalized content delivery based on screenshot analysis, according to one or more embodiments. The method starts at block 702, where a screenshot analysis record is received by the computer system from the electronic device or generated based on received screenshot data. The screenshot analysis record can include a variety of metadata regarding a screenshot, such as depicted in FIG. 5. The method 700 continues to block 704, where an interest score is computed. In one or more embodiments, the interest score may be computed utilizing collaborative filtering, content-based filtering, attention mechanisms, personalized rankings, and/or other suitable techniques. The method 700 continues to block 706, where a check is made to determine if the computed interest score exceeds a predetermined threshold. If, at block 706, it is determined that the computed interest score does not exceed a predetermined threshold, then the method 700 continues to block 712, where the received screenshot analysis record is ignored, and accordingly, the received screenshot analysis record is not used as a basis for personalized content delivery.

If it is determined, at block 706, that the computed interest score does exceed a predetermined threshold, then the method 700 continues to block 708, where a personalized content asset is obtained. In one or more embodiments, the personalized content asset may be obtained from a repository of content. The repository can include targeted advertisements, video clips, images, audio files, promotional announcements, public service announcements, and so on. The method 700 then continues to block 710, where the personalized content asset is sent to the electronic device. In one or more embodiments, the personalized content asset is sent to the electronic device via HTTP/HTTPS (Hypertext Transfer Protocol/Secure), WebSockets, MQTT (Message Queuing Telemetry Transport), XMPP (Extensible Messaging and Presence Protocol), Firebase Cloud Messaging (FCM), and/or other suitable techniques.

As can now be appreciated, disclosed embodiments provide techniques for personalized content delivery based on screenshot analysis. The personalized content can be tailored to match interests, preferences, and behaviors, making the content more relevant and engaging for users. Moreover, the personalized content is likely to be content that aligns with a user's preferences, without the user having to sift through unrelated material, thereby improving efficiency. Screenshots are often shared, and disclosed embodiments utilize the sharing of screenshots to achieve a more fine-grained level of personalization than previously possible. Thus, disclosed embodiments provide significant benefits, including increased relevance and engagement, time efficiency, enhanced user experience, better decision-making, and emotional connection. By leveraging screenshots, personalized content delivery promotes the goal of users receiving information and recommendations that is most pertinent to their needs and interests, leading to a more satisfying and productive digital experience.

In the above-described methods, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

1. A communication device comprising:
at least one output device, including a display;
a communication system;
a memory having stored thereon a screenshot analysis (SA) module comprising executable program instructions; and
at least one processor communicatively coupled to the display, the communication system, and the memory, the at least one processor executing program instructions of the SA module and is configured to cause the communication device to:
obtain image data for a screenshot that is rendered on the display;
create a screenshot analysis record (SAR) by performing an analysis of the screenshot;
compute an interest score for the screenshot;
record the interest score as part of the SAR;
transmit the SAR, including the computed interest score, to a remote computing device that supports a personalization engine and a recommendation engine;
receive, in part based on the SAR and the computed interest score exceeding a predetermined threshold, at least one personalized content asset from the remote computing device; and
modify the display by rendering the at least one personalized content asset on the display.

2. The communication device of claim 1, wherein to perform the analysis of the screenshot, the at least one processor further performs at least one of an optical character recognition (OCR) process on the screenshot and a machine-learning based object identification process on the screenshot.

3. The communication device of claim 2, wherein further the at least one processor:
creates a text record as part of the SAR, wherein the text record includes text recognized by the OCR process; and
creates an object list as part of the SAR, wherein the object list includes objects recognized by the machine-learning based object identification process.

4. The communication device of claim 1, wherein to create the SAR, the at least one processor is configured to cause the communication device to:
create a unique identifier for the screenshot;
record a sharing count that represents a number of times the screenshot has been shared;
record a sharing destination count of the screenshot that represents a number of distinct sharing destinations for the screenshot; and
create a sharing information record that is included as part of the SAR, wherein the SAR comprises the unique identifier, the sharing count, and the sharing destination count.

5. The communication device of claim 4, wherein to create the unique identifier, the at least one processor further computes a hash of the image data that comprises the screenshot.

6. The communication device of claim 4, wherein further the at least one processor records a sharing destination in the sharing information record, wherein the sharing destination includes one of a URL, email address, and telephone number.

7. The communication device of claim 4, wherein
the interest score is indicative of a level of interest in the screenshot by the user, and the at least one processor computes the interest score for the screenshot based at least in part on the sharing count and the sharing destination count.

8. (canceled)

9. A method comprising:
obtaining, by a processor of a communication device, image data for a screenshot that is rendered on a display of the communication device;
creating a screenshot analysis record (SAR) by performing an analysis of the screenshot;
computing an interest score for the screenshot;
recording the interest score as part of the SAR;
transmitting the SAR to a remote computing device that supports a personalization engine and a recommendation engine;
receiving, from the remote computing device, in part based on the SAR and the computed interest score exceeding a predetermined threshold, at least one personalized content asset; and
modifying the display by rendering the at least one personalized content asset on the display.

10. The method of claim 9, further comprising performing at least one of an optical character recognition (OCR) process on the screenshot, and a machine-learning based object identification process on the screenshot.

11. The method of claim 9, wherein creating the SAR further comprises:
creating a unique identifier for the screenshot;
recording a sharing count that represents a number of times the screenshot has been shared, and a sharing destination count of the screenshot that represents a number of distinct sharing destinations for the screenshot; and
creating a sharing information record that is includes as part of the SAR, wherein the SAR comprises the unique identifier, the sharing count, and the sharing destination count.

12. The method of claim 11, wherein creating a unique identifier comprises computing a hash of the image data that comprises the screenshot.

13. The method of claim 11, further comprising recording a sharing destination in the sharing information record, wherein the sharing destination includes one of a URL, email address, and telephone number.

14. The method of claim 10, further comprising creating a text record as part of the SAR, wherein the text record includes text recognized by the OCR process.

15. The method of claim 10, further comprising creating an object list as part of the SAR, wherein the object list includes objects recognized by the machine-learning based object identification process.

16. (canceled)

17. A computer program product comprising a non-transitory computer readable medium having program instructions that when executed by a processor of a communication device comprising a display, configure the communication device to perform functions comprising:
obtaining image data for a screenshot that is rendered on the display;
creating a screenshot analysis record (SAR) by performing an analysis of the screenshot;
computing an interest score for the screenshot;
recording the interest score as part of the SAR;
transmitting the SAR to a remote computing device that supports a personalization engine and a recommendation engine;
receiving, from the remote computing device, in part based on the SAR and the computed interest score exceeding a predetermined threshold, at least one personalized content asset; and
modifying the display by rendering the at least one personalized content asset on the display.

18. The computer program product of claim 17, wherein the program instructions for creating the SAR further comprises program instructions for:
creating a unique identifier for the screenshot;
recording a sharing count that represents a number of times the screenshot has been shared, and a sharing destination count of the screenshot that represents a number of distinct sharing destinations for the screenshot; and
creating a sharing information record as part of the SAR, wherein the SAR comprises the unique identifier, the sharing count, and the sharing destination count.

19. The computer program product of claim 18, further comprising program instructions for creating the unique identifier by computing a hash of the image data that comprises the screenshot.

20. The computer program product of claim 17, further comprising program instructions for performing at least one of an optical character recognition (OCR) process on the screenshot and a machine-learning based object identification process on the screenshot.

21. The communication device of claim 1, wherein further the at least one processor is configured to cause the communication device to compute the interest score as a function of one or more of a number of objects in the object list, text indicated in a text record, one or more entities listed in an entities field, a number of times the screenshot image has been accessed and/or shared, and a number of entities that are also indicated as interests in a user profile.

22. The method of claim 8, wherein computing the interest score further comprises computing the interest score as a function of one or more of a number of objects in the object list, text indicated in a text record, one or more entities listed in an entities field, a number of times the screenshot image has been accessed and/or shared, and a number of entities that are also indicated as interests in a user profile.
